(19) United States
(12) Patent Application Publication
(10) Pub. No.: US 2023/0222898 A1
(43) Pub. Date: Jul. 13, 2023

(54) VEHICLE POSE OPTIMIZATION FOR SENSOR MONITORING

(71) Applicant: Ford Global Technologies, LLC, Dearborn, MI (US)

(72) Inventors: Stuart C. Salter, White Lake, MI (US); John Robert Van Wiemeersch, Novi, MI (US); Brendan Francis Diamond, Grosse Pointe, MI (US); Tarik Safir, Chesterfield (GB); Sam Harris, Billericay (GB)

(73) Assignee: Ford Global Technologies, LLC, Dearborn, MI (US)

(21) Appl. No.: 17/572,911

(22) Filed: Jan. 11, 2022

(51) Int. Cl. G08G 1/01; G08G 1/127

(52) U.S. Cl. CPC G08G 1/0116; G08G 1/0141; G08G 1/0145; G08G 1/0133; G08G 1/127

(57) ABSTRACT

Upon identifying a plurality of target regions for a monitored region, priority levels for the respective target regions are determined based on a user input. Vehicle sensors that are available to monitor the respective target regions are determined based on the priority levels for the respective target regions and parameters for the respective vehicle sensors. Based on the available vehicle sensors and the priority levels for the respective target regions, a pose is determined for a vehicle that optimizes monitoring of the target regions. The vehicle is operated to the pose.

### BACKGROUND

Infrastructure elements, e.g., roadside infrastructure units (RSUs) and the like, may monitor surroundings of an area to detect objects in or approaching the area. The infrastructure elements may be able to obtain data about objects, hazards, etc. approaching the area. For example, the infrastructure elements may include sensors having fields of view that encompass portions of the area's surroundings. Infrastructure sensor fields of view can be limited, e.g., because the sensors may be mounted so as to have a fixed field of view, or so that, even if the sensor field of view can be adjusted, infrastructure coverage of an area is nonetheless limited or lacking.

### BRIEF DESCRIPTION OF THE DRAWINGS

FIG. 1 is a block diagram illustrating an example vehicle control system.

FIG. 2 is a plan view of a sensor assembly including first and second sensors.

FIGS. 3A-3B are diagrams illustrating determining a pose for a vehicle to optimize monitoring of target regions for a monitored region according to the system of FIG. 1.

FIGS. 4A-4B are diagrams illustrating determining a pose for a vehicle to optimize monitoring of target regions for a monitored region based on an infrastructure sensor according to the system of FIG. 1.

FIGS. 5A-5B are diagrams illustrating determining a pose for a vehicle to optimize monitoring of target regions for a monitored region based on a secondary vehicle according to the system of FIG. 1.

FIGS. 6A-6B are diagrams illustrating determining poses for vehicles to optimize monitoring of target regions for monitored regions according to the system of FIG. 1.

FIG. 7 is a flowchart of an example process for operating the vehicle to monitor the target regions.

### DETAILED DESCRIPTION

A plurality of target regions around a monitored regions can be identified. An infrastructure element can monitor at least some of one target region. For example, the infrastructure element can include an infrastructure sensor having a field of view that encompasses at least some of the one target region. However, due to physical constraints of the infrastructure element, locations of the target regions relative to the monitored region, and/or objects around the monitored region obstructing the field of view of the infrastructure sensor, the infrastructure element may be unable to monitor all of the one target region or additional target regions. That is, at least one infrastructure element may be warranted to monitor each target region.

Advantageously, techniques described herein can reduce a number of infrastructure elements needed to monitor the target regions. A vehicle computer can determine vehicle sensors that are available to monitor the target regions based on priority levels (as discussed below) for the respective target regions and parameters for the respective vehicle sensors. The vehicle computer can then determine a pose for the vehicle that optimizes monitoring of the target regions with the available vehicle sensors, and can operate the vehicle to the determined pose to monitor the target regions. Deploying vehicle sensors to monitor the target regions allows the vehicle computer to operate the vehicle to update a location and orientation of the vehicle sensors relative to the target regions, thereby optimizing monitoring of the target regions, which can increase a likelihood of identifying objects, including pedestrians or vehicles, in the target regions. Further, optimizing monitoring of the target regions based on the priority levels of the target regions allows the vehicle computer to prioritize monitoring of target regions, e.g., target regions with an increased risk of unauthorized pedestrians or vehicles can be assigned a higher priority.

A system includes a computer including a processor and a memory, the memory storing instructions executable by the processor such that the computer is programmed to, upon identifying a plurality of target regions for a monitored region, determine priority levels for the respective target regions based on a user input. The computer is further programmed to determine vehicle sensors that are available to monitor the respective target regions based on the priority levels for the respective target regions and parameters for the respective vehicle sensors. The computer is further programmed to, based on the available vehicle sensors and the priority levels for the respective target regions, determine a pose for a vehicle that optimizes monitoring of the target regions. The computer is further programmed to operate the vehicle to the pose.

The computer can be further programmed to identify the plurality of target regions based on map data.

The computer can be further programmed to identify the plurality of target regions based on a second user input.

The pose for the vehicle can be outside of the monitored region.

The computer can be further programmed to determine the pose for the vehicle based additionally on an infrastructure sensor monitoring at least one of the target regions.

The computer can be further programmed to determine the pose for the vehicle based additionally on a sensor in a secondary vehicle monitoring at least one of the target regions.

The system can include a second computer included in a secondary vehicle. The second computer can include a second processor and a second memory, the second memory can store instructions executable by the second processor such that the second computer can be programmed to determine the sensor is available to monitor the at least one target region based on the priority level for the at least one target region and parameters for the sensor. The second computer can be further programmed to, upon determining a secondary pose for the secondary vehicle that allows the sensor to monitor the at least one target region, operate the secondary vehicle to the secondary pose.

The computer can be further programmed to determine the pose for the vehicle based additionally on determining sensors in a secondary vehicle that are available for monitoring the target regions.

The computer can be further programmed to, based on the pose, the available sensors in the secondary vehicle, and the priority levels for the respective target regions, determine a secondary pose for the secondary vehicle that optimizes monitoring of the target regions.

The system can include a second computer included in a secondary vehicle. The second computer can include a second processor and a second memory, the second memory can store instructions executable by the second processor such that the second computer can be programmed to, upon receiving, from the computer, the secondary pose for the secondary vehicle, operate the secondary vehicle to the secondary pose.

The computer can be further programmed to determine the available sensors in the secondary vehicle based on receiving a message from a second computer specifying the available sensors in the secondary vehicle.

The system can include a second computer included in a secondary vehicle. The second computer can include a second processor and a second memory, the second memory can store instructions executable by the second processor such that the second computer can be programmed to determine the available sensors in the secondary vehicle based on the priority levels for the respective target regions and parameters for the respective sensors in the secondary vehicle.

The computer can be further programmed to, upon operating the vehicle to the pose, transition the vehicle to a minimal power state and activate a first available vehicle sensor to monitor one target region.

The computer can be further programmed to, upon detecting an object via data from the first available vehicle sensor, transition the vehicle to an ON state.

The computer can be further programmed to activate a second available vehicle sensor, wherein the second available vehicle sensor has a higher power draw than the first available vehicle sensor.

The computer can be further programmed to actuate at least one of exterior lights, a speaker, or a horn.

A method includes, upon identifying a plurality of target regions for a monitored region, determining priority levels for the respective target regions based on a user input. The method further includes determining vehicle sensors that are available to monitor the respective target regions based on the priority levels for the respective target regions and parameters for the respective vehicle sensors. The method further includes, based on the available vehicle sensors and the priority levels for the respective target regions, determining a pose for a vehicle that optimizes monitoring of the target regions. The method further includes operating the vehicle to the pose.

The method can further include identifying the plurality of target regions based on one of map data or a second user input.

The method can further include determining the pose for the vehicle based additionally on an infrastructure sensor monitoring at least one of the target regions.

The method can further include determining the pose for the vehicle based additionally on a sensor in a secondary vehicle monitoring at least one of the target regions.

Further disclosed herein is a computing device programmed to execute any of the above method steps. Yet further disclosed herein is a computer program product, including a computer readable medium storing instructions executable by a computer processor, to execute an of the above method steps.

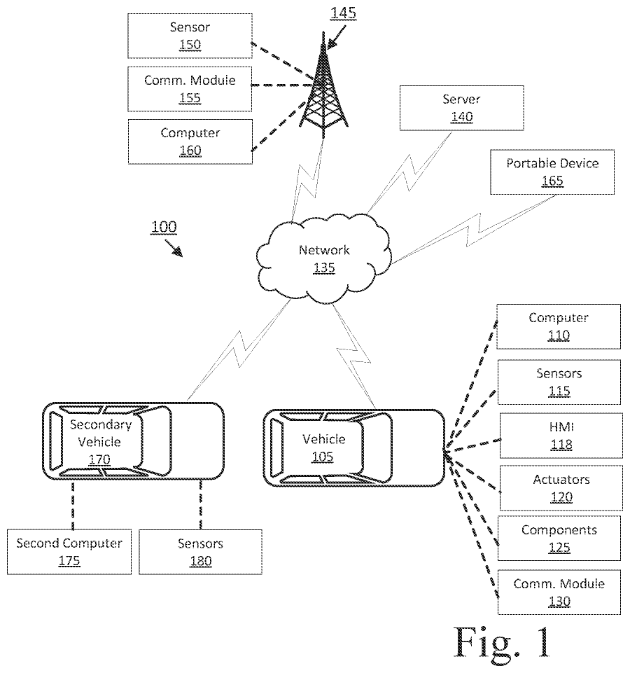

With reference to FIGS. 1-6B, an example vehicle control system 100 includes a vehicle 105. A vehicle computer 110 in the vehicle 105 receives data from sensors 115, including a first sensor 115a and a second sensor 115b. The vehicle computer 110 is programmed to, upon identifying a plurality of target regions 310 for a region 300, determine priority levels for the respective target regions 310 based on a user input. The vehicle computer 110 is further programmed to identify or determine vehicle sensors 115 that are available to monitor the respective target regions 310 based on the priority levels for the respective target regions 310 and parameters for the respective vehicle sensors 115. The vehicle computer 110 is further programmed to, based on the available vehicle sensors 115 and the priority levels for the respective target regions 310, determine a pose for the vehicle 105 that optimizes monitoring of the target regions 310. The vehicle computer 110 is further programmed to operate the vehicle 105 to the pose.

Turning now to FIG. 1, the vehicle 105 includes the vehicle computer 110, sensors 115, actuators 120 to actuate various vehicle components 125, and a vehicle communications module 130. The communications module 130 allows the vehicle computer 110 to communicate with a remote server computer 140, a portable device 165, and/or other vehicles, e.g., via a messaging or broadcast protocol such as Dedicated Short Range Communications (DSRC), cellular, IEEE 802.11, Bluetooth®, Ultra-Wideband (UWB), and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC (application specific integrated circuit) that is manufactured for a particular operation, e.g., an ASIC for processing sensor data and/or communicating the sensor data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 110.

The vehicle computer 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicle 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communications network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices, e.g., sensors 115, an actuator 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, secondary vehicles 170, etc., relative to the location of the vehicle 105. The sensors 115 may further alternatively or additionally, for example, include camera sensor(s) 115, e.g. front view, side view, etc., providing images from an area surrounding the vehicle 105. In the context of this disclosure, an object is a physical, i.e., material, item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the vehicle 105. As one example, the data may be image data of the environment around the vehicle 105. In such an example, the image data may include one or more objects and/or markings, e.g., lane markings, on or along a road. Image data herein means digital image data, e.g., comprising pixels with intensity and color values, that can be acquired by camera sensors 115. The sensors 115 can be mounted to any suitable location in or on the vehicle 105, e.g., on a vehicle 105 bumper, on a vehicle 105 roof, etc., to collect images of the environment around the vehicle 105.

The vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the vehicle computer 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications (cellular and/or DSRC, etc.) to another vehicle, and/or to a remote server computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth®, UWB, IEEE 802.11, dedicated short range communications (DSRC), and/or wide area networks (WAN), including the Internet, providing data communication services.

The network 135 represents one or more mechanisms by which a vehicle computer 110 may communicate with remote computing devices, e.g., the remote server computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, UWB, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or or some other wide area network.

An infrastructure element 145 includes a physical structure such as a tower, pole, etc., on or in which infrastructure sensors 150, as well as an infrastructure communications module 155 and computer 160 can be housed, mounted, stored, and/or contained, and powered, etc. One infrastructure element 145 is shown in FIG. 1 for ease of illustration, but the system 100 could include a plurality of infrastructure elements 145.

An infrastructure element 145 is typically stationary, i.e., fixed to and not able to move from a specific physical location. The infrastructure sensors 150 may include one or more sensors such as described above for the vehicle 105 sensors 115, e.g., LIDAR, radar, cameras, ultrasonic sensors, etc. The infrastructure sensors 150 are fixed or stationary. That is, each infrastructure sensor 150 is mounted to the infrastructure element 145 so as to have a substantially unmoving and unchanging field of view.

Infrastructure sensors 150 thus provide field of views that can differ from fields of view of vehicle 105 sensors 115 in several respects. First, because infrastructure sensors 150 typically have a substantially constant field of view, determinations of vehicle 105 and object locations typically can be accomplished with fewer and simpler processing resources than if movement of the infrastructure sensors 150 also had to be accounted for. Further, the infrastructure sensors 150 include an external perspective of the vehicle 105 and can sometimes detect features and characteristics of objects not in the vehicle 105 sensors 115 field(s) of view and/or can provide more accurate detection, e.g., with respect to vehicle 105 location and/or movement with respect to other objects. Yet further, infrastructure sensors 150 typically can communicate with the computer 160 via a wired connection, whereas vehicles 105 typically can communicate with infrastructure elements 145 only wirelessly, or only at very limited times when a wired connection is available. Wired communications are typically more reliable and can be faster than wireless communications such as vehicle-to-infrastructure communications or the like.

The infrastructure communications module 155 and computer 160 typically have features in common with the vehicle computer 110 and vehicle communications module 130, and therefore will not be described further to avoid redundancy. Although not shown for ease of illustration, the infrastructure element 145 also includes a power source such as a battery, solar power cells, and/or a connection to a power grid.

The portable device 165 can be a conventional computing device, i.e., including one or more processors and one or more memories, programmed to provide operations such as disclosed herein. The portable device 165 can be any one of a variety of computers that can be used while carried by a person, e.g., a smartphone, a tablet, a personal digital assistant, a smart watch, a key fob, etc. Further, the portable device 165 can be accessed via the network 135, e.g., the Internet, a cellular network, and/or or some other wide area network.

A secondary vehicle 170 is a vehicle detected by the vehicle 105 and available to monitor one or more target regions 310. The secondary vehicle 170 includes a second computer 175. The second computer 175 includes a second processor and a second memory such as are known. The second memory includes one or more forms of computer-readable media, and stores instructions executable by the second computer 175 for performing various operations, including as disclosed herein.

Additionally, the secondary vehicle 170 may include sensors 180, actuators (not shown) to actuate various vehicle components (not shown), and a vehicle communications module (not shown). The sensors 180, actuators to actuate various vehicle components, and the vehicle communications module typically have features in common with the sensors 115, actuators 120 to actuate various host vehicle components 125, and the vehicle communications module 130, and therefore will not be described further to avoid redundancy.

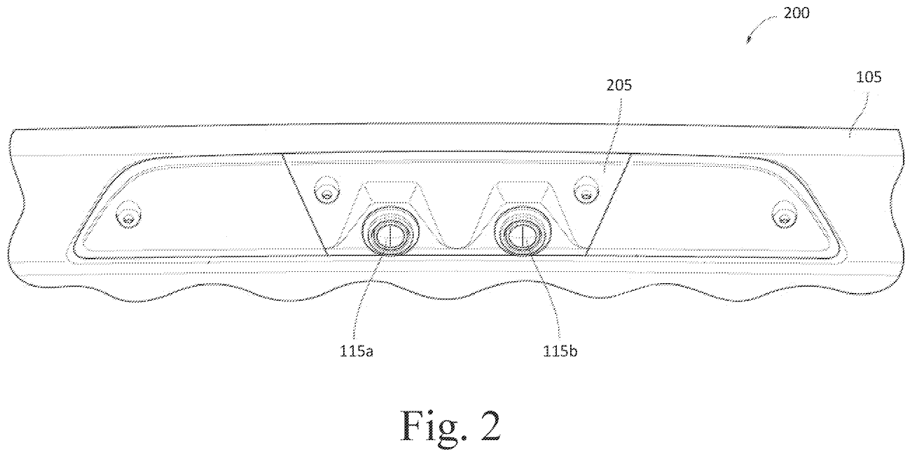

Turning now to FIG. 2, the vehicle 105 may include one or more sensors 115 and one or more sensor assemblies in which sensors 115 can be mounted, such as the illustrated sensor assembly 200. The sensor assembly 200 includes a housing 205, a first sensor 115a, and a second sensor 115b. The housing 205 may be mounted, e.g., via fasteners, welding, adhesive, etc., to the vehicle 105. The housing 205 may be mounted to a rear, front, and/or side of the vehicle 105 exterior.

The housing 205 retains the first sensor 115a and the second sensor 115b. The first sensor 115a can have different parameters than the second sensor 115b. As used herein, a “parameter” is a datum or data describing a physical characteristic of a sensor 115. Non-limiting examples of parameters include resolution of data from the sensor 115, sensing media (e.g., ultrasound, radar, LIDAR, visible light, etc.), size (e.g., a diameter) of a lens, shape of a lens (e.g., a radius of curvature), a field of view (as discussed below), etc.

In the present example, the first sensor 115a is a type suitable for detecting objects, e.g., in an environment around the vehicle 105. In particular, the first sensor 115a can be a radar. A radar, as is known, uses radio waves to determine the relative location, angle, and/or velocity of an object by tracking the time required for the radio waves generated by the radar to reflect back to the radar. Alternatively, the first sensor 115a could be an ultrasonic sensor, a UWB transceiver, or any other suitable type of sensor. The first sensor 115a runs at a scanning rate, which is an occurrence interval of generating and transmitting the radio waves, e.g., twice per second, once every two seconds, etc. The power draw, i.e., the rate of power consumption, of the first sensor 115a depends on the scanning rate, i.e., typically is higher for higher scanning rates.

The second sensor 115b in the present example is a type suitable for providing detailed data about the environment around the vehicle 105. For example, the second sensor 115b can be a camera. A camera, as is known, detects electromagnetic radiation in some range of wavelengths. For example, the camera may detect visible light, infrared radiation, ultraviolet light, or a range of wavelengths including visible, infrared, and/or ultraviolet light. The power draw of the second sensor 115b in the present example is higher than the power draw of the first sensor 115a for any scanning rate of the first sensor 115a. Alternatively, the second sensor 115b can be an ultrasonic sensor, a UWB transceiver, or any other suitable sensor.

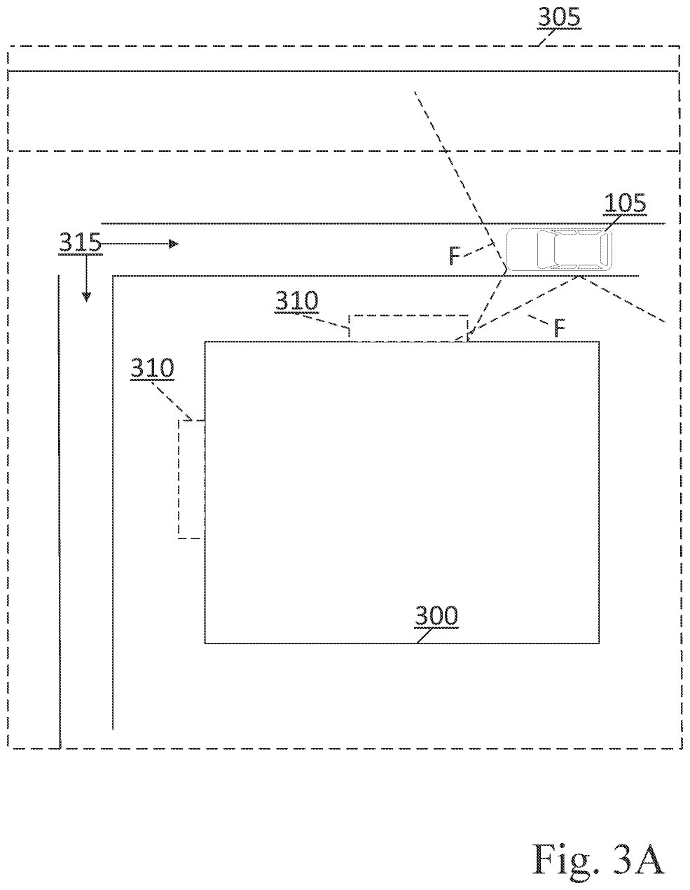

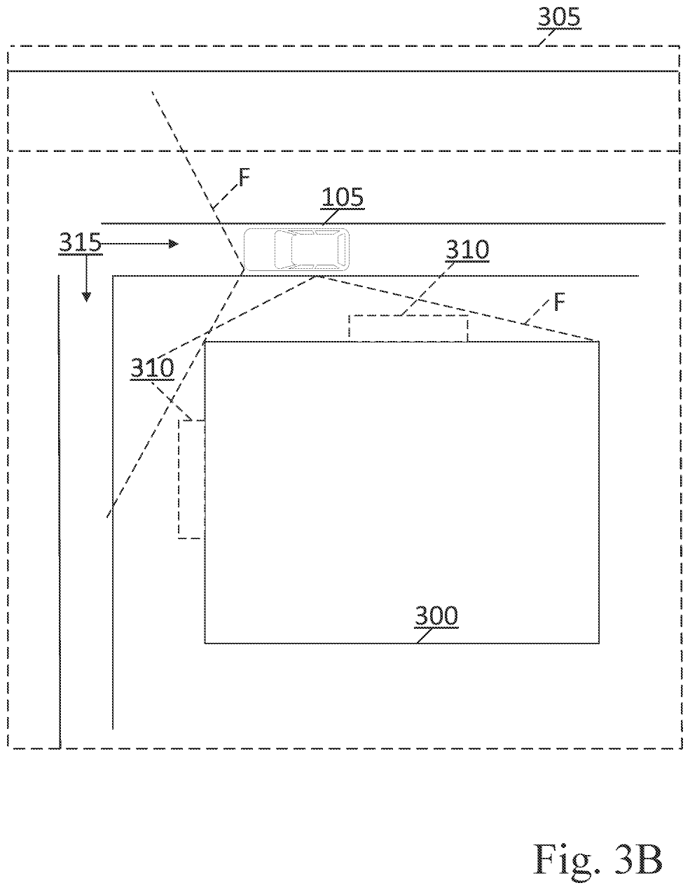

The first sensor 115a and the second sensor 115b can be arranged in the housing so that respective fields of view F (see FIGS. 3-6B) of the first sensor 115a and the second sensor 115b at least partially overlap. For example, as shown in FIGS. 3-6B, the fields of view F of the first and second sensors 115a, 115b may be identical. The fields of view F of the first and second sensors 115a, 115b include an area or, more typically, a three-dimensional space, i.e., a volume, around the vehicle 105. For example, the first and second sensors 115a, 115b can be mounted into a fixed position relative to the housing 205. The first and second sensors 115a, 115b can face in generally a same direction relative to the vehicle 105.

The vehicle 105 may include a plurality of sensor assemblies 200. The sensor assemblies 200 may include a same or different type of first sensor 115a when compared to each other. Additionally, or alternatively, the first sensors 115a may have same or different parameters relative to each other. The sensor assemblies 200 may include a same or different type of second sensor 115b. Additionally, or alternatively, the second sensors 115b may have same or different parameters relative to each other.

FIGS. 3A-6B are diagrams illustrating a vehicle 105 operating around an example monitored region 300 (which in this example is a building). The monitored region 300 is an area or, more typically, a three-dimensional space, i.e., a volume, for external monitoring. The vehicle computer 110 may be programmed to maintain the vehicle 105 within a monitoring range 305 of the monitored region 300. A monitoring range 305 is defined by an area or, more typically, a three-dimensional space, i.e., a volume, around the monitored region 300. The vehicle computer 110 is authorized to monitor one or more monitored regions 300 within the monitoring range 305. The monitoring range 305 may, for example, be specified by a user input, e.g., detected by the HMI 118 in the same manner as discussed below regarding a first user input. As another example, the monitoring range 305 may be specified by sensor 115 parameters of the vehicle 105. In such an example, the monitoring range 305 may corresponding to a space around a specified monitored region 300 within which the vehicle computer 110 can monitor the specified monitored region 300.

The vehicle computer 110 may be programmed to determine that the vehicle 105 is within the monitoring range 305 based on sensor 115 data. For example, the vehicle computer 110 may be programmed to determine that the vehicle 105 is within the monitoring range 305, e.g., by GPS-based geo-fencing. A geo-fence herein has the conventional meaning of a boundary for an area or a volume defined by sets of geo-coordinates. In such an example, a geo-fence specifies a boundary of the monitoring range 305. The vehicle computer 110 can then determine that the vehicle 105 is within the monitoring range 305 based on the location data of the vehicle 105 indicating the vehicle 105 is within the corresponding geo-fence. As another example, the vehicle computer 110 may determine whether the vehicle 105 is within the monitoring range 305 based on data, e.g., map data, received from the remote server computer 140. For example, the vehicle computer 110 may receive a location of the vehicle 105, e.g., from a sensor 115, a navigation system, a remote server computer 140, etc. The vehicle computer 110 can compare the location of the vehicle 105 to the map data, e.g., to determine whether the vehicle 105 is within the monitoring range 305 specified in the map data. As yet another example, the vehicle computer 110 may determine whether the vehicle 105 is within the monitoring range 305 based on terrestrial GPS, e.g., according to known triangulation techniques.

The vehicle computer 110 can identify target regions 310 for the monitored region 300. As used here, a “target region” is an area or, more typically, a three-dimensional space, i.e., a volume, outside and immediately adjacent to the monitored region 300, i.e., an area or volume extending outwardly from the monitored region 300. A target region 310 is typically an area of interest that is not included in, or is only partially included in, a monitored region 300. A target region 310 can, for example, be include and/or be adjacent to (i.e., sharing a border with and next to) areas of ingress and/or egress to the monitored region 300.

The vehicle computer 110 can, for example, identify the target regions 310 based on a first user input. In such an example, the vehicle computer 110 may actuate the HMI 118 to detect the first user input specifying the target regions 310. For example, the HMI 118 may be actuated by the vehicle computer 110 to display a representation of the monitored region 300 on a touchscreen display to which the user can provide input to specify the target regions 310. In other words, the HMI 118 may activate sensors 115 that can detect the user specifying locations of the target regions 310 relative to the representation of the monitored region 300. Upon detecting the first user input, the HMI 118 can provide the first user input to the vehicle computer 110, and the vehicle computer 110 can identify the target regions 310 for the monitored region 300.

As another example, the vehicle computer 110 can identify the target regions 310 based on map data. For example, the vehicle computer 110 can access a high-definition (HD) map, e.g., stored in a memory of the vehicle computer 110, identifying the target regions 310 for the monitored region 300. As another example, the vehicle computer 110 can receive the HD map from a remote server computer 140. An HD map, as is known, is a map of a geographic area similar to GOOGLE MAPS™. HD maps can differ from maps provided for viewing by human users such as GOOGLE MAPS in that HD maps can include higher resolution, e.g., less than 10 centimeters (cm) in x and y directions. HD maps include road data, e.g., curbs, lane markers, pothole locations, dirt or paved road, etc., traffic data, e.g., position and speed of vehicles on a road, number of vehicles on a road, etc., and environment data, e.g., locations of signs, buildings, foliage, etc.

As another example, the vehicle computer 110 can obtain sensor 115 data of the monitored region 300 and can identify the target regions 310 by analyzing the sensor 115 data, e.g., using known image processing techniques. For example, the vehicle computer 110 can identify a target region 310 based on identifying, e.g., a door, a window, a gate, etc., via the sensor 115 data. As another example the vehicle computer 110 can receive a message from the remote server computer 140 or the portable device 165, e.g., via the network 135, specifying the target regions 310 for the monitored region 300.

Upon identifying the target regions 310, the vehicle computer 110 can determine priority levels for the target regions 310. As used herein, a “priority level” is a measure that the vehicle computer 110 can use to identify or determine a sensor 115 to monitor the target region 310, and that indicates a priority of a target region 310 to be monitored relative to other target regions 310. The priority level may be specified as a text string, e.g., “high”, “medium”, or “low”. As another example, the priority level may be specified as a number, e.g., an integer on a scale from 1 to 3, inclusive. In this example, a priority level of 3 represents a target region 310 that has a lower priority for monitoring than a priority level of 2 or 1, and a priority level of 1 represents a target region 310 that has a higher priority for monitoring than a priority level 2.

The vehicle computer 110 can, for example, determine a priority level of a target region 310 based on a second user input. In such an example, the vehicle computer 110 may actuate the HMI 118 to detect the second user input specifying the priority level for the target region 310. For example, the HMI 118 may be actuated and/or instructed by the vehicle computer 110 to display virtual buttons on a touchscreen display that the user can select to specify the priority levels for the target regions 310. In other words, the HMI 118 may activate sensors 115 that can detect the user specifying priority levels of the target regions 310. Upon detecting the second user input, the HMI 118 can provide the second user input to the vehicle computer 110, and the vehicle computer 110 can determine the priority level for the target region 310.

As another example, the vehicle computer 110 can determine the priority level for the target region 310 based on the map data. That is, in addition to identifying the target region 310, the HD map may specify the priority level for the target region 310. As another example, the vehicle computer 110 can determine the priority level for the target region 310 based on receiving a message from the remote server computer 140 or the portable device 165, e.g., via the network 135, specifying the priority level for the target region 310.

The vehicle computer 110 can determine one or more available sensors 115 to monitor the target region 310 based on the priority level for the target region 310, e.g., sensors 115 with higher resolutions, wider range of detection ability in varying light conditions, etc., may be allocated to higher priority target regions 310. For example, the vehicle computer 110 may maintain a look-up table, or the like, that associates various sensor 115 parameters with corresponding priority levels. The vehicle computer 110 can, for example, access the look-up table and determine sensor 115 parameters based on the stored priority level matching the determined priority level. The sensor 115 parameters maintained in the look-up table may specify minimum parameters for the sensor 115 to monitor a target region 310 having the corresponding priority level. That is, at least some sensors 115 may be available to monitor different target regions 310 having different priority levels. An example look-up table is shown in Table 1 below:

TABLE 1

| | Priority |
|---|---|
| Sensor Parameter | Level |
| Visible Light Detection Capabilities and Minimum Resolution | 1 |
| Infrared Radiation Detection Capabilities | 2 |
| Visible Light Detection Capabilities | 3 |

The vehicle computer 110 can then determine the available sensors 115 based on the determined sensor 115 parameters. For example, the vehicle computer 110 may maintain a second look-up table that associates various types of sensors 115 on the vehicle 105 with corresponding parameters. The vehicle computer 110 can, for example, access the look-up table and determine the available sensor(s) 115 based on the stored parameter matching the determined parameter. The look-up tables may be stored, e.g., in a memory of the vehicle computer 110.

Upon determining the available sensors 115 to monitor the target regions 310, the vehicle computer 110 determines a pose for the vehicle 105 that optimizes monitoring of the target regions 310. That is, the vehicle computer 110 determines a pose for the vehicle 105 such that fields of view F of the available sensors 115 maximize the target regions 310 being monitored while prioritizing the monitored target regions 310 based on the respective priority levels. The vehicle computer 110 can determine the pose by applying optimization techniques to optimize the monitoring for the target regions 310 based on the available sensors 115 and the priority levels for the target regions 310. The determined pose for the vehicle 105 is outside the monitored region 300. That is, when the vehicle 105 is in the determined pose, one or more sensors 115 face the monitored region 300, i.e., fields of view F of one or more sensors 115 encompass at least a portion of the monitored region 300. The fields of view F of the sensors 115 may be stored, e.g., in a memory of the vehicle computer 110.

The pose of the vehicle 105 may be specified in six degrees-of-freedom. Six degrees-of-freedom conventionally, and in this document, refers to freedom of movement of an object in three-dimensional space, e.g., translation along three perpendicular axes and rotation about each of the three perpendicular axes. A six degree-of-freedom pose of the vehicle 105 means a location relative to a coordinate system (e.g., a set of coordinates specifying a positing in the coordinate system, e.g., X, Y, and Z coordinates) and an orientation (e.g., a yaw, a pitch, and a roll) about each axis in the coordinate system. The pose of the vehicle 105 can be determined in real world coordinates based on orthogonal x, y, and z axes and roll, pitch, and yaw rotations about the x, y, and z axes, respectively. The pose of the vehicle 105 locates the vehicle 105 with respect to the real world coordinates.

Additionally, or alternatively, the vehicle computer 110 may determine pose of the vehicle 105 based on available monitoring regions 315 around the monitored region 300. That is, the vehicle computer 110 may determine the pose of the vehicle 105 such that the vehicle 105 remains within a monitoring region 315. A monitoring region 315 is a specified area of ground surface for parking a vehicle. A monitoring region 315 may be on a street or road, e.g., an area alongside a curb or an edge of the street, a driveway, a parking lot or structure or portion thereof, etc.

The vehicle computer 110 can identify monitoring regions 315 around the monitored region 300 based on sensor 115 data. For example, the vehicle computer 110 can obtain sensor 115 data of the environment around the vehicle 105 and analyze the sensor 115 data, e.g., according to known image processing techniques, to identify the monitoring regions 315. As another example, the vehicle computer 110 can identify the monitoring regions 315 based on a third user input. In such an example, the vehicle computer 110 can actuate the HMI 118 to detect the third user input specifying the monitoring regions 315, e.g., in substantially the same manner as discussed above regarding determining the first user input. As another example, the vehicle computer 110 can identify the monitoring regions 315 based on the map data. That is, the map data may additionally specify locations of monitoring regions 315 within the monitoring range 305. As another example, the vehicle computer 110 can identify the monitoring regions 315 based on receiving a message from the remote server computer 140 or the portable device 165, e.g., via the network 135, specifying the monitoring regions 315.

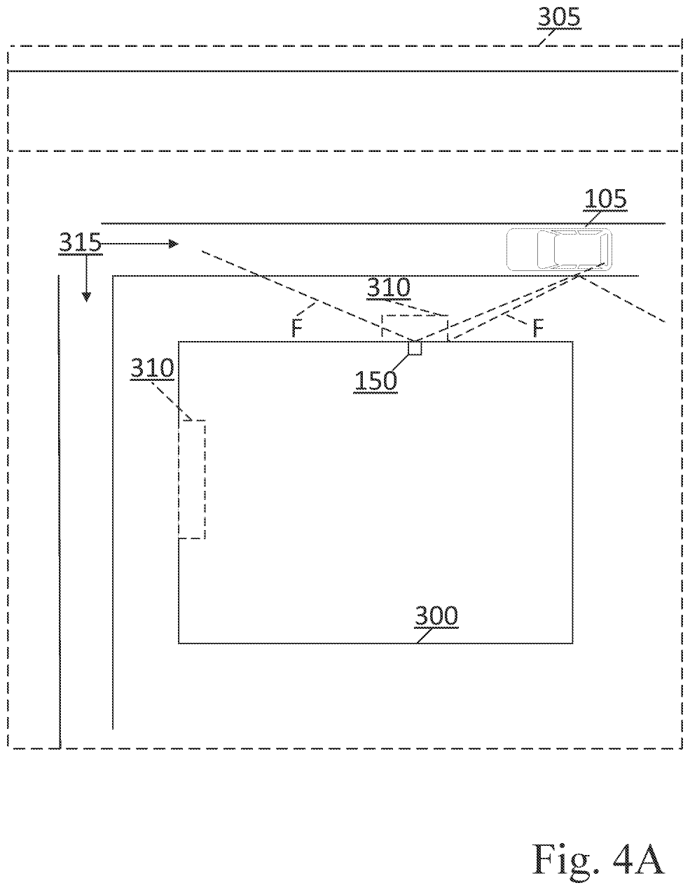

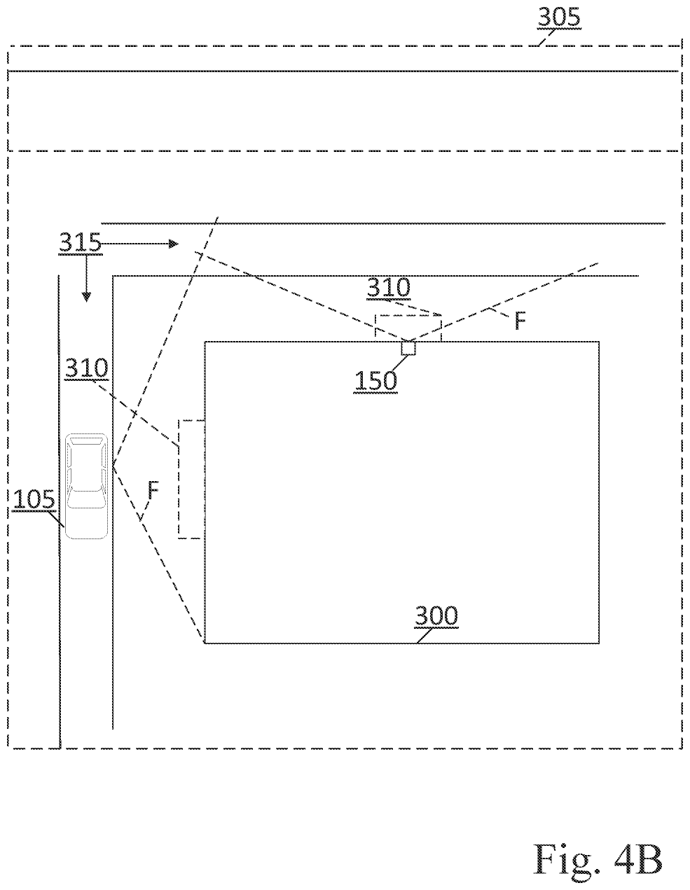

Additionally, or alternatively, the vehicle computer 110 can determine the pose of the vehicle 105 based on the infrastructure sensor 150 (see FIGS. 4A-4B). For example, the infrastructure sensor 150 may have a field of view F that includes a target region 310, as shown in FIGS. 4A-4B. The infrastructure element 145 may provide the field of view F to the vehicle computer 110, e.g., via the network 135. In an example in which parameters of the infrastructure sensor 150 satisfy the minimum parameters specified in the look-up table for monitoring the target region 310, the vehicle computer 110 can ignore the target region 310 monitored by the infrastructure sensor 150 when determining the pose. That is, the vehicle computer 110 can determine the pose such that the field of view F of an available second sensor 115b encompasses a target region 310 monitored by the infrastructure sensor 150, as shown in FIG. 4B. In an example in which the parameters of the infrastructure sensor 150 do not satisfy the minimum parameters specified in the look-up table for monitoring the target region 310, the vehicle computer 110 can determine the pose such that the field of view F of an available second sensor 115b encompasses the target region 310.

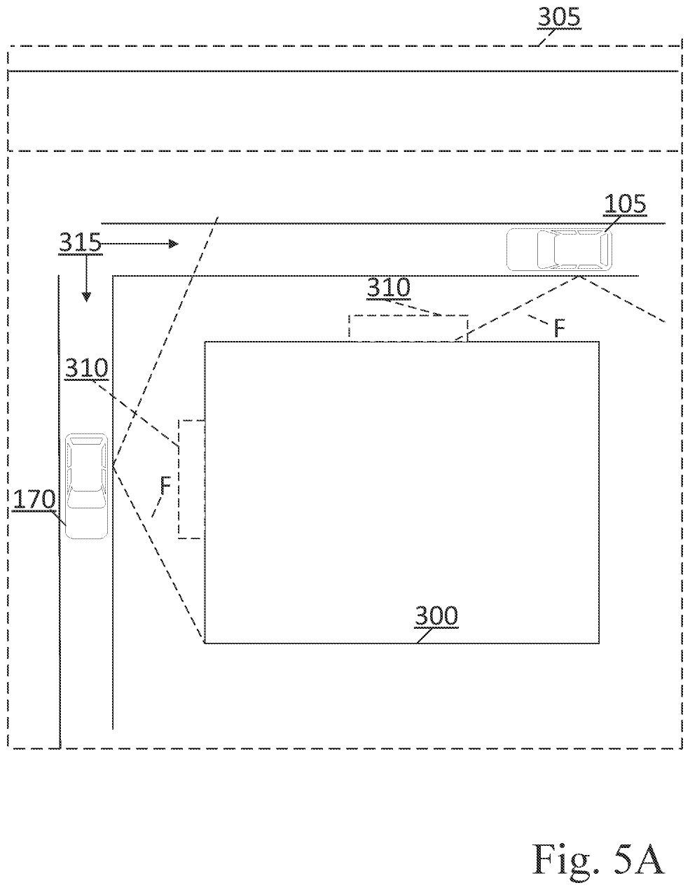

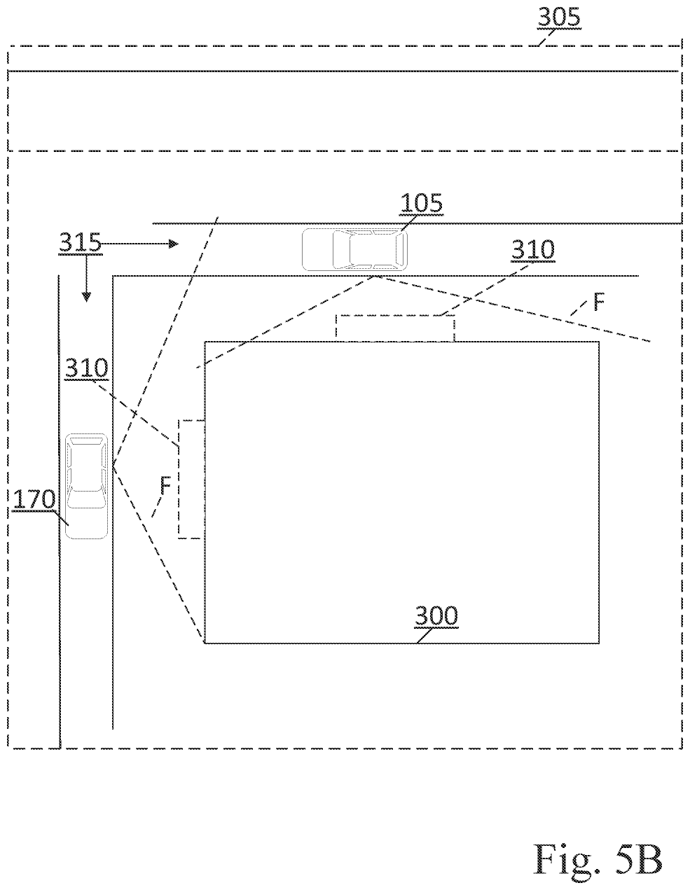

Additionally, or alternatively, the vehicle computer 110 can determine the pose of the vehicle 105 based on detecting a secondary vehicle 170 within the monitoring range 305 (see FIGS. 5A-5B). For example, the vehicle computer 110 can obtain sensor 115 data of the environment around the vehicle 105 and can detect the secondary vehicle 170 via the sensor 115 data, e.g., using object classification and/or identification techniques discussed below. As another example, the second computer can provide location data of the secondary vehicle 170 to the vehicle computer 110, e.g., via the network 135, and the vehicle computer 110 can compare the location data to the monitoring range 305, as discussed above.

Upon detecting the secondary vehicle 170, the vehicle computer 110 can, for example, determine the pose of the vehicle 105 based on a sensor 180 of the secondary vehicle 170 monitoring at least one target region 310. For example, the secondary vehicle 170 may have a sensor 180 having a field of view F that includes the target region 310, as shown in FIGS. 5A-5B. The second computer 175 can provide the field of view F of the sensor 180 in the secondary vehicle 170 to the vehicle computer 110, e.g., via the network 135. As another example, the vehicle computer 110 can determine the field of view F of the sensor 180 based on a secondary pose of the secondary vehicle 170. The vehicle computer 110 can determine the pose for the vehicle 105 based on the field of view F and the parameters of the sensor 180 in the secondary vehicle 170, e.g., in the manner discussed above regarding the infrastructure sensor 150.

The vehicle computer 110 can determine the secondary pose of the secondary vehicle 170 based on sensor 115 data. For example, the vehicle computer 110 can obtain sensor 115 data including the secondary vehicle 170 and analyze the sensor 115 data, e.g., according to known image processing techniques, to determine an intermediate pose of the secondary vehicle 170 relative to the vehicle 105. The vehicle computer 110 can then combine the pose of the vehicle 105 and the intermediate pose of the secondary vehicle 170, e.g., using known data processing techniques, to determine the secondary pose of the secondary vehicle 170. That is, the vehicle computer 110 can determine the intermediate pose of the secondary vehicle 170 in local coordinates, i.e., a Cartesian coordinate system having an origin on the vehicle 105, and can then transform the local coordinates into real-world coordinates to determine the secondary pose of the secondary vehicle 170. As another example, the second computer 175 can provide the secondary pose of the secondary vehicle 170 to the vehicle computer 110, e.g., via the network 135.

As another example, upon detecting the secondary vehicle 170, the vehicle computer 110 can determine the pose for the vehicle 105 and an updated secondary pose for the secondary vehicle 170 such that these poses optimize monitoring of the target regions 310, e.g., by applying optimization techniques to optimize the monitoring for the target regions 310 based on the available sensors 115, the available sensors 180 in the secondary vehicle 170, and the priority levels for the target regions 310. In this situation, upon determining the updated secondary pose for the secondary vehicle 170, the vehicle computer 110 can provide the updated secondary pose to the secondary vehicle 170. For example, the vehicle computer 110 can transmit the updated secondary pose to the second computer 175, e.g., via the network 135.

The vehicle computer 110 can, for example, determine an updated pose for the vehicle 105 based on detecting the secondary vehicle 170 moving within, entering, or departing the monitoring range 305. For example, upon detecting the secondary vehicle 170 is within the monitoring range 305, the vehicle computer 110 can determine an updated pose for the vehicle 105 and/or a secondary pose for the secondary vehicle 170, e.g., in the manner discussed above. As another example, the vehicle computer 110 can determine an updated pose for the vehicle 105 based on determining the secondary vehicle 170 has moved, e.g., to an updated secondary pose, outside of the monitoring range 305, etc. The vehicle computer 110 can determine the secondary vehicle 170 has moved based on, e.g., sensor 115 data, receiving a message from the secondary vehicle 170 and/or a remote server computer 140, etc. Determining an updated pose for the vehicle 105 based on other vehicles within the monitoring range 305 allows the vehicle computer 110 to continuously optimize monitoring of the target regions 310.

As another example, the vehicle computer 110 can determine an updated pose for the vehicle 105 based on receiving a message, e.g., via the network 135, from the remote server computer 140 or the portable device 165 specifying the updated pose, updated target regions 310, and/or updated priority levels for the target regions 310. As another example, the vehicle computer 110 can determine an updated pose for the vehicle 105 based on a fourth user input, e.g., specifying the updated pose, updated target regions 310, and/or updated priority levels for the target regions 310. The vehicle computer 110 can actuate the HMI 118 to detect the fourth user input, e.g., in substantially the same manner as discussed above regarding detecting the first user input.

Upon determining the pose (or the updated pose) for the vehicle 105, the vehicle computer 110 can operate the vehicle 105 to the pose (or the updated pose). For example, the vehicle computer 110 can actuate one or more vehicle components 125 to move the vehicle 105 to the pose (or the updated pose).

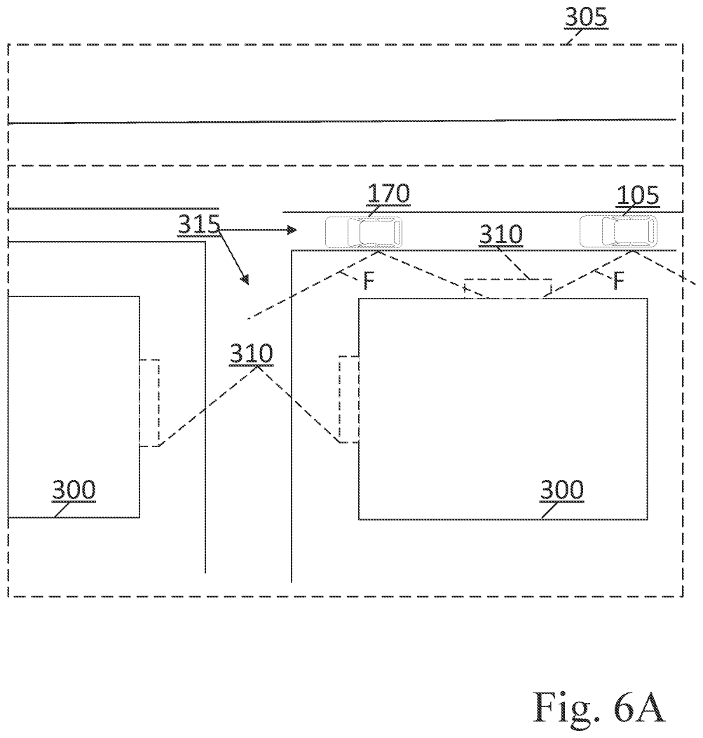

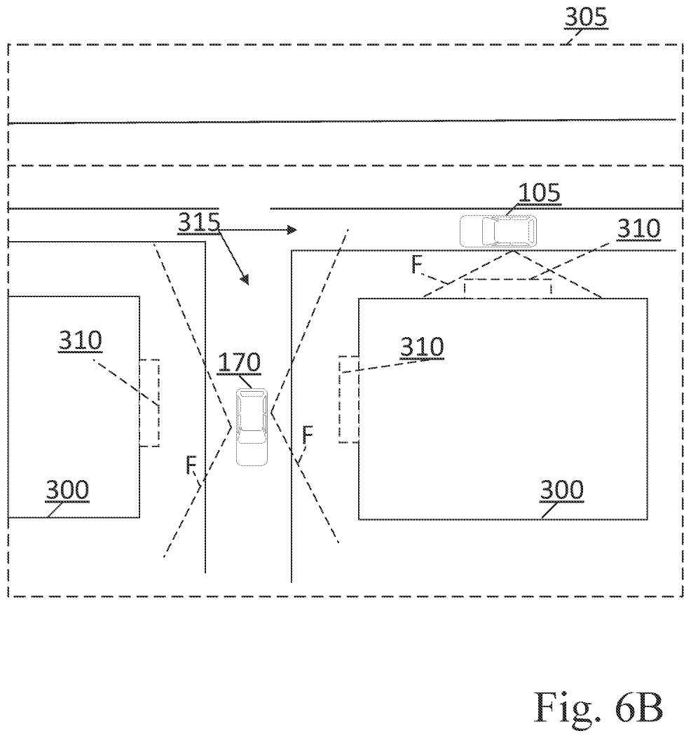

Additionally, the vehicle computer 110 can determine target regions 310 for other monitored regions 300 within the monitoring range 305, e.g., in substantially the same manner as discussed above regarding determining the target regions 310 (see FIG. 6A). In such an example, the vehicle computer 110 can determine respective poses for corresponding vehicles 105, 170 that optimize monitoring for the target regions 310 for the monitored region 300 and the other monitored regions 300, e.g., in the manner discussed above regarding determining the pose and/or secondary pose (see FIG. 6B).

The vehicle computer 110 is programmed to manage startup and shutdown of the vehicle 105. For example, upon determining the vehicle 105 is at or in the determined pose based on location data and/or map data, the vehicle computer 110 can shut down the vehicle 105. That is, the vehicle computer 110 can transition the vehicle 105 between activation states. As another example, the vehicle computer 110 can shut down the vehicle 105 based on receiving a request from, e.g., the remote server computer 140, user input to a power button in a passenger cabin of the vehicle 105, etc. In this context, an “activation state” specifies a power state of vehicle components 125 and sensors 115, i.e., whether, and/or an amount that, a component 125 and/or sensor 115 is electrically powered during startup and/or shutdown of the vehicle 105, e.g., unpowered, powered with a specific power supply, etc.

The activation state can be one of an off state, a minimal power state, and an ON state. In the ON state, all vehicle components 125 and sensors 115 are available to be actuated by the vehicle computer 110 to operate the vehicle 105. In the off state, the vehicle components 125 and sensors 115 are substantially powered off to conserve energy when the vehicle 105 is not in use, i.e., parked in a monitoring region 315. In the minimal power state, vehicle components 125 and/or sensors 115 may draw power from a power supply for less than all operation when the vehicle 105 is in the ON state. That is, the vehicle components 125 and/or sensors 115 draw power for a specific, limited set of operations, e.g., monitoring the environment around the vehicle 105.

The power supply provides electricity to one or more components 125 and sensors 115. The power supply can include one or more batteries, e.g., 12-volt lithium-ion batteries, and one or more power networks to supply power from the batteries to the components 125 and sensors 115. In the ON state, the power supply provides power to all of the vehicle components 125 and sensors 115. In the minimal power state, the power supply may provide power to a subset, i.e., some but less than all, of the vehicle components 125 and sensors 115. For example, the power supply may provide power to the first sensor 115a but not to the second sensor 115b. In the off state, the power supply does not provide power to the vehicle components 125 or sensors 115. The vehicle computer 110 can receive power from the power supply regardless of the activation state. The vehicle computer 110 can actuate the power supply based on the activation state.

The vehicle computer 110 may be programmed to transition the vehicle 105 from the off state to the minimal power state based on a time of day. For example, the vehicle computer 110 can receive and/or store a sunset time for a current day and a sunrise time for a next day, e.g., from the remote server computer 140 via the network 135. The vehicle computer 110 may maintain a clock and can compare a current time to the received and/or stored sunset and sunrise times. If the current time is after the sunset time and before the sunrise time, then the vehicle computer 110 transitions the vehicle 105 from the off state to the minimal power state. If the current time is before the sunset time or after the sunrise time, then the vehicle computer 110 maintains the vehicle 105 in the off state. That is, the vehicle computer 110 may transition the vehicle 105 to the minimal power state during nighttime. As another example, the vehicle computer 110 can transition the vehicle 105 to the minimal power state at a predetermined time, e.g., specified by an owner of the vehicle 105 and/or monitored region 300. The predetermined time may be stored, e.g., in a memory of the vehicle computer 110. Additionally, or alternatively, the vehicle computer 110 may be programmed to transition the vehicle 105 to the minimal power state based on receiving a message from the remote server computer 140 or the portable device 165, e.g., via the network 135.

In the minimal power state, the vehicle computer 110 monitors a target region 310. Specifically, the vehicle computer 110 activates a first sensor 115a based on a position of the target region 310 relative to the vehicle 105. For example, the vehicle computer 110 can activate a first sensor 115a that faces the target region 310. That is, the vehicle computer 110 activates a first sensor 115a having a field of view F that includes the target region 310 of the monitored region 300. Activating the first sensor in the minimal power state can provide an energy-efficient way to monitor the target regions 310. Additionally, not activating the second sensor, which is more energy-intensive than the first sensor, in the minimal power state saves energy. The energy savings can be important when the vehicle is in the minimal power state and relying on a finite supply of stored energy.

After activating the first sensor 115a, the vehicle computer 110 then instructs the first sensor 115a to run at a scanning rate. The scanning rate may be determined empirically, e.g., based on testing that allows for determining a scanning rate that allows the first sensor 115a to detect an object 320 moving through the field of view F of the first sensor 115a while minimizing the power draw of the first sensor 115a. The vehicle computer 110 can detect objects 320 around the vehicle 105 based on data from the first sensor 115a. For example, the vehicle computer 110 can monitor data from the first sensor 115a to detect an object 320 has moved into the field of view F of the first sensor 115a, e.g., based on determining that radio waves in some direction indicate a shorter distance than previous radio waves in that direction.

The vehicle computer 110 is programmed to transition the vehicle 105 from the minimal power state to the ON state based on detecting an object 320 via data from the first sensor 115a. Additionally, or alternatively, the vehicle computer 110 may be programmed to transition the vehicle 105 from the minimal power state to the ON state based on receiving a message from the remote server computer 140 or the portable device 165, e.g., via the network 135. When the vehicle computer 110 transitions the vehicle 105 to the ON state, the vehicle computer 110 activates the second sensor 115b of the sensor assembly 200. Additionally, the vehicle computer 110 may activate exterior lighting on the vehicle 105, e.g., to illuminate a field of view F of the second sensor 115b, when the vehicle computer 110 transitions the vehicle 105 to the ON state.

In the ON state, the vehicle computer 110 is programmed to analyze data from the second sensor 115b based on the priority level for the target region 310. For example, when the priority level for the target region 310 is 1, or “high”, the vehicle computer 110 is programmed to identify the detected object 320 as a pedestrian and determine whether the pedestrian is authorized or unauthorized, as discussed below. Additionally, when the priority level for the target region 310 is 2, or “medium”, the vehicle computer 110 is programmed to identify the detected object 320 as a pedestrian, as discussed below. Additionally, when the priority level for the target region 310 is 3, or “low”, the vehicle computer 110 is programmed to verify a presence of the detected object 320, as discussed below.

The vehicle computer 110 can, for example, be programmed to classify and/or identify object(s) 320 based on data from the second sensor 115b. For example, object classification techniques can be used, e.g., in the vehicle computer 110 based on LIDAR sensor 115 data, camera sensor 115 data, etc., to classify a detected object 320 as mobile or stationary, i.e., non-movable. Additionally, or alternatively, object identification techniques can be used, e.g., in the vehicle computer 110 based on LIDAR sensor 115 data, camera sensor 115 data, etc., to identify a type of object 320, e.g., a vehicle, a pedestrian, etc., as well as physical features of objects. Non-limiting examples of objects 320 include a pedestrian, another vehicle, an animal, etc.

Any suitable techniques may be used to interpret sensor 115 data and/or to classify objects 320 based on sensor 115 data. For example, camera and/or LIDAR image data can be provided to a classifier that comprises programming to utilize one or more conventional image classification techniques. For example, the classifier can use a machine learning technique in which data known to represent various objects, is provided to a machine learning program for training the classifier. Once trained, the classifier can accept as input vehicle sensor 115 data, e.g., an image, and then provide as output, for each of one or more respective regions of interest in the image, an identification and/or a classification (i.e., mobile or stationary) of one or more objects 320 or an indication that no object 320 is present in the respective region of interest. Further, a coordinate system (e.g., polar or cartesian) applied to an area proximate to the vehicle 105 can be applied to specify locations and/or areas (e.g., according to the vehicle 105 coordinate system, translated to global latitude and longitude geo-coordinates, etc.) of objects 320 identified from sensor 115 data. Yet further, the vehicle computer 110 could employ various techniques for fusing (i.e., incorporating into a common coordinate system or frame of reference) data from different sensors 115 and/or types of sensors 115, e.g., LIDAR, radar, and/or optical camera data.

Upon identifying the type of object 320 as a pedestrian, the vehicle computer 110 determines whether the pedestrian is authorized or unauthorized based on the data from the second sensor 115b. The vehicle computer 110 can perform facial recognition to determine whether the pedestrian's face is an authorized face, i.e., a face of a known authorized person, e.g., stored in a memory. The vehicle computer 110 can use any suitable facial-recognition technique, e.g., template matching; statistical techniques such as principal component analysis (PCA), discrete cosine transform, linear discriminant analysis, locality preserving projections, Gabor wavelet, independent component analysis, or kernel PCA; neural networks such as neural networks with Gabor filters, neural networks with Markov models, or fuzzy neural networks; etc.

The vehicle computer 110 can be programmed to actuate vehicle components 125 to output an audio and/or visual alert indicating an object 320 is within the target region 310 upon detecting a trigger. In this situation, the vehicle computer 110 can actuate one or more vehicle components 125, e.g., speakers, a display, a horn, exterior lights, etc., to output the alert. Additionally, or alternatively, the vehicle computer 110 may provide a message, e.g., via the network, to the remote server computer 140 or the portable device 165 indicating an object 320 is within the target region 310.

For purposes of this document, a “trigger” is a specific condition that can be true or false (and is one or the other) at a given time. The trigger may be determined based on the priority level for the target region 310. For example, when the priority level is 3 for the target region 310, the trigger may be detecting, via the data from the second sensor 115b, a presence of an object 320 within the target region 310. As another example, when the priority level is 2 for the target region 310, the trigger may be identifying, via the data from the second sensor 115b, an object 320 within the target region 310 is a pedestrian. As another example, when the priority level is 1 for the target region 310, the trigger may be identifying, via the data from the second sensor 115b, an object 320 within the target region 310 is an unauthorized pedestrian.

Upon detecting an absence of the trigger, the vehicle computer 110 may be programmed to transition the vehicle 105 to the minimal power state. For example, upon detecting an absence of an object 320 within the target region 310 (when the priority level is 3), identifying a type of object 320 other than a pedestrian, e.g., an animal, (when the priority level is 2), or determining that the pedestrian is authorized (when the priority level is 3), the vehicle computer 110 may initiate a timer. The timer may have a predetermined duration, e.g., 5 seconds, 30 seconds, 1 minute, etc. The predetermined duration may be stored, e.g., in a memory of the vehicle computer 110. If the vehicle computer 110 fails to detect a trigger via data from the second sensor 115b prior to expiration of the timer, then the vehicle computer 110 can transition the vehicle 105 to the minimal power state. If the vehicle computer 110 detects a trigger via data from the second sensor 115b prior to expiration of the timer, then the vehicle computer 110 maintains the vehicle 105 in the ON state.

The second computer 175 may be programmed to identify target regions 310 and priority levels for target regions 310, e.g., in substantially the same manner as discussed above. Upon identifying the target regions 310 and the priority levels for the target regions 310, the second computer 175 may be programmed to determine available sensors 180 for monitoring the target regions 310, e.g., in substantially the same manner as discussed above. The second computer 175 can then provide a message to the vehicle computer 110 specifying the available sensors 180 for the secondary vehicle 170. For example, the second computer 175 can transmit the message, e.g., via the network 135, to the vehicle computer 110. Additionally, or alternatively, the second computer 175 can determine the secondary pose for the secondary vehicle 170 that allows the available sensors 180 to monitor the target regions 310, e.g., based on the fields of views F of the available sensors 180 in the secondary vehicle 170 and/or monitoring regions 315 within the monitoring range 305.

Upon determining the secondary pose or receiving the updated secondary pose, the second computer 175 can operate the secondary vehicle 170 to the secondary pose (or the updated secondary pose). For example, the second computer 175 can actuate one or more components in the secondary vehicle 170 to move the secondary vehicle 170 to the secondary pose (or the updated secondary pose).

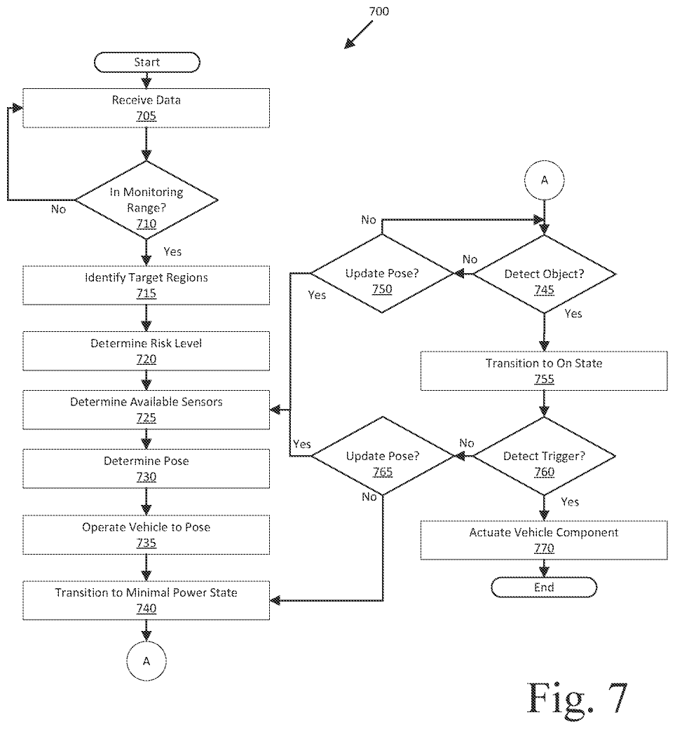

FIG. 7 is a flowchart of an example process 700 executed in a computer 110, 175 in a vehicle 105, 170 according to program instructions stored in a memory thereof for optimizing monitoring of target regions 310 for a region 300. Process 700 includes multiple blocks that can be executed in the illustrated order. Process 700 could alternatively or additionally include fewer blocks or can include the blocks executed in different orders.

The process 700 begins in a block 705. In the block 705, a computer 110, 175 receives data from one or more sensors 115, 180, e.g., via a vehicle network, from a remote server computer 140, e.g., via a network 135, and/or from a computer in another vehicle, e.g., via V2V communications. For example, the computer 110, 175 can receive location data, e.g., geo-coordinates, of the vehicle 105, 170, e.g., from a sensor 115, 180, a navigation system, etc. The process 700 continues in a block 710.

In the block 710, the computer 110, 175 determines whether the vehicle 105, 170 is within a monitoring range 305 of the monitored region 300 based on map data and/or the received data, e.g., image data and/or location data, as discussed above. If the computer 110, 175 determines that the vehicle 105, 170 is within the monitoring range 305, then the process 700 continues in a block 715. Otherwise, the process 700 returns to the block 705.

In the block 715, the computer 110, 175 identifies target regions 310 for the monitored region 300, e.g., based on a first user input, map data, received data, a message from a remote server computer 140 or a portable device 165, etc., as discussed above. The process 700 continues in a block 720.

In the block 720, the computer 110, 175 identifies priority levels for the target regions 310, e.g., based on a second user input, map data, a message from a remote server computer 140 or a portable device 165, etc., as discussed above. The process 700 continues in a block 725.

In the block 725, the computer 110, 175 determines available sensors 115, 180 for monitoring the target regions 310 based on the priority levels for the target regions 310 and parameters of the sensors 115, 180, as discussed above. The process 700 continues in a block 730.

In the block 730, the computer 110, 175 determines a pose for the vehicle 105, 170 that optimizes monitoring of the target regions 310. As discussed above, the computer 110, 175 applies optimization techniques to determine the pose based on the available sensors 115, 180 and the priority levels of the target regions 310. The computer 110, 175 can determine the pose based additionally on an infrastructure sensor 150 and/or another vehicle 105, 170, as discussed above. The process 700 continues in a block 735.

In the block 735, the computer 110, 175 operates the vehicle 105, 170 to the pose, as discussed above. The computer 110, 175 may transition the vehicle 105, 170 to an off state upon determining that the vehicle 105, 170 is at the pose. Alternatively, the computer 110, 175 may maintain the vehicle 105, 170 in an ON state. The process 700 continues in a block 740.

In the block 740, the computer 110, 175 transitions the vehicle 105, 170 to a minimal power state when the vehicle 105, 170 is at the pose, as discussed above. In the minimal power state, the computer 110, 175 activates a first sensor 115a to run at a specified scanning rate and to monitor a corresponding target region 310, as discussed above. The process 700 continues in a block 745.

In the block 745, the computer 110, 175 determines whether an object 320 has been detected. The computer 110, 175 can detect objects 320 around the vehicle 105, 170 via data from the first sensor 115a, 180a, as discussed above. If the computer 110, 175 detects an object 320 from the first sensor 115a, 180a data, then the process 700 continues in a block 755. Otherwise, the process 500 continues in a block 750.

In the block 750, the computer 110, 175 determines whether to update the pose of the vehicle 105, 170. The computer 110, 175 can determine to update the pose of the vehicle 105, 170 based on, e.g., detecting movement of another vehicle 170, receiving a message from the remote server computer 140, the portable device 165, another computer 110, 175, or receiving a fourth user input, as discussed above. If the computer 110, 175 determines to update the pose of the vehicle 105, 170, then the process 700 returns to the block 725. Otherwise, the process 700 returns to the block 745.

In the block 755, the computer 110, 175 transitions the vehicle 105, 170 to the ON state and activates a second sensor 115b, 180b to monitor the target region 310, as discussed above. Additionally, the computer 110, 175 may activate exterior lighting on the vehicle 105, 170, e.g., to illuminate a field of view F of the second sensor 115b, 180b, as discussed above. The process 700 continues in a block 760.

In the block 760, the computer 110, 175 determines whether a trigger is detected. The computer 110, 175 can receive and analyze data from the second sensor 115b, 180b to determine whether the trigger is detected based on the priority level for the target region 310, as discussed above. If the computer 110, 175 determines a trigger is detected, then the process 700 continues in a block 770. Otherwise, the process 700 continues in a block 765.

In the block 765, the computer 110, 175 determines whether to update the pose of the vehicle 105, 170. The block 765 is substantially the same the block 750 of process 700 and therefore will not be described further to avoid redundancy. If the computer 110, 175 determines to update the pose of the vehicle 105, 170, then the process 700 returns to the block 725. Otherwise, the process 700 returns to the block 740.

In the block 770, the computer 110, 175 actuates one or more vehicle components 125, e.g., to output an alert indicating an object 320 is within the target region 310, as discussed above. Additionally, or alternatively, the computer 110, 175 may provide a message, e.g., via the network, to the remote server computer 140 or the portable device 165 indicating an object 320 is within the target region 310. The process 700 ends following the block 770.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor such that the computer is programmed to:
upon identifying a plurality of target regions for a monitored region, determine priority levels for the respective target regions based on a user input;
determine vehicle sensors that are available to monitor the respective target regions based on the priority levels for the respective target regions and parameters for the respective vehicle sensors;
based on the available vehicle sensors and the priority levels for the respective target regions, determine a pose for a vehicle that optimizes monitoring of the target regions; and
operate the vehicle to the pose.

2. The system of claim 1, wherein the computer is further programmed to identify the plurality of target regions based on map data.

3. The system of claim 1, wherein the computer is further programmed to identify the plurality of target regions based on a second user input.

4. The system of claim 1, wherein the pose for the vehicle is outside of the monitored region.

5. The system of claim 1, wherein the computer is further programmed to determine the pose for the vehicle based additionally on an infrastructure sensor monitoring at least one of the target regions.

6. The system of claim 1, wherein the computer is further programmed to determine the pose for the vehicle based additionally on a sensor in a secondary vehicle monitoring at least one of the target regions.

7. The system of claim 6, further comprising a second computer included in a secondary vehicle, the second computer including a second processor and a second memory, the second memory storing instructions executable by the second processor such that the second computer is programmed to:
determine the sensor is available to monitor the at least one target region based on the priority level for the at least one target region and parameters for the sensor; and
upon determining a secondary pose for the secondary vehicle that allows the sensor to monitor the at least one target region, operate the secondary vehicle to the secondary pose.

8. The system of claim 1, wherein the computer is further programmed to determine the pose for the vehicle based additionally on determining sensors in a secondary vehicle that are available for monitoring the target regions.

9. The system of claim 8, wherein the computer is further programmed to, based on the pose, the available sensors in the secondary vehicle, and the priority levels for the respective target regions, determine a secondary pose for the secondary vehicle that optimizes monitoring of the target regions.

10. The system of claim 9, further comprising a second computer included in a secondary vehicle, the second computer including a second processor and a second memory, the second memory storing instructions executable by the second processor such that the second computer is programmed to, upon receiving, from the computer, the secondary pose for the secondary vehicle, operate the secondary vehicle to the secondary pose.

11. The system of claim 8, wherein the computer is further programmed to determine the available sensors in the secondary vehicle based on receiving a message from a second computer specifying the available sensors in the secondary vehicle.

12. The system of claim 11, further comprising a second computer included in a secondary vehicle, the second computer including a second processor and a second memory, the second memory storing instructions executable by the second processor such that the second computer is programmed to determine the available sensors in the secondary vehicle based on the priority levels for the respective target regions and parameters for the respective sensors in the secondary vehicle.

13. The system of claim 1, wherein the computer is further programmed to, upon operating the vehicle to the pose, transition the vehicle to a minimal power state and activate a first available vehicle sensor to monitor one target region.

14. The system of claim 13, wherein the computer is further programmed to, upon detecting an object via data from the first available vehicle sensor, transition the vehicle to an ON state.

15. The system of claim 14, wherein the computer is further programmed to activate a second available vehicle sensor, wherein the second available vehicle sensor has a higher power draw than the first available vehicle sensor.

16. The system of claim 14, wherein the computer is further programmed to actuate at least one of exterior lights, a speaker, or a horn.

17. A method, comprising:
upon identifying a plurality of target regions for a monitored region, determining priority levels for the respective target regions based on a user input;
determining vehicle sensors that are available to monitor the respective target regions based on the priority levels for the respective target regions and parameters for the respective vehicle sensors;
based on the available vehicle sensors and the priority levels for the respective target regions, determining a pose for a vehicle that optimizes monitoring of the target regions; and
operating the vehicle to the pose.

18. The method of claim 17, further comprising identifying the plurality of target regions based on one of map data or a second user input.

19. The method of claim 17, further comprising determining the pose for the vehicle based additionally on an infrastructure sensor monitoring at least one of the target regions.

20. The method of claim 17, further comprising determining the pose for the vehicle based additionally on a sensor in a secondary vehicle monitoring at least one of the target regions.
